(19) United States
(12) Patent Application Publication
(10) Pub. No.: US 2011/0153188 A1
(43) Pub. Date: Jun. 23, 2011

(54) GLOBAL POSITIONING SYSTEM NAVIGATION DEVICE WITHOUT REQUIRING MAP DATABASE

(75) Inventor: AN-TSUN TENG, Jhubei City (TW)

(73) Assignee: GTA ELECTRONICS CO., LTD., TAIPEI HSIEN (TW)

(21) Appl. No.: 12/640,143

(22) Filed: Dec. 17, 2009

(51) Int. Cl. G01C 21/36

(52) U.S. Cl. 701/201

(57) ABSTRACT

A GPS navigation device without requiring a map database includes a casing, an input module installed on the casing for inputting turning point coordinates and pre-turning point coordinates, a global positioning system, a memory device and a display device. The global positioning system generates position coordinates of the GPS navigation device by a satellite positioning method, outputs a direction instruction to guide a traveling direction according to the turning point coordinates and the pre-turning point coordinates, and display the information on the display device. By pre-planning a route and inputting the turning point and pre-turning point coordinates, direction instructions can be given when the GPS navigation device is situated at position of such coordinates, and thus the GPS navigation device achieves the navigation effect without requiring a map database and also achieves the effects of saving power and lowering cost.

### FIELD OF THE INVENTION

The present invention relates to a global positioning system (GPS) navigation device and a method thereof, in particular to a GPS navigation device without requiring a map database.

### BACKGROUND OF THE INVENTION

Global positioning system (GPS) has been applied in many areas of our daily life, and GPS satellites above earth surface are used to locate a position of a satellite signal receiver on the earth surface precisely, and the GPS is applied most extensively in the area of navigation.

In addition to the function of providing information of a current position, a GPS navigation device also has an important function of planning a route. Users can set a place of departure and a destination in advance, and the navigation device will plan the best route by using a built-in map database to guide users step by step in the direction of the destination.

Such navigation device can be installed in a motor vehicle or any other transportation means having a power source. With sufficient power, the navigation device can adopt a processor with a high computational capability to operate with a map database that requires a huge consumption of computational capability. However, a handheld GPS device generally comes with a limited power supply which does not allow the navigation device to plan for the routes for several times, or usually does not come with a built-in map database either. Therefore, the conventional handheld GPS devices at most can provide the function of outputting position coordinates only. In general, the handheld GPS devices have a processor with a low computational capability and a limited power supply, and it is difficult to use such GPS device for navigations.

### SUMMARY OF THE INVENTION

Therefore, it is a primary objective of the present invention to provide a GPS device and a method applied for navigation without using a built-in map database.

To achieve the foregoing and other objectives, the present invention discloses a GPS navigation device without requiring a map database, and the GPS navigation device comprises: a casing; an input module, installed on the casing, for inputting turning point coordinates and pre-turning point coordinates; a global positioning system, installed in the casing and electrically coupled to the input module, for generating position coordinates of the GPS navigation device by a satellite positioning method, outputting a direction instruction according to the turning point coordinates and the pre-turning point coordinates to provide a traveling direction; a memory device, installed in the casing and electrically coupled to the global positioning system, for storing the turning point coordinates and the pre-turning point coordinates; and a display device, installed on the casing and electrically coupled to the global positioning system, for displaying the direction instruction, wherein the display device is a direction indicating lamp module or a display screen, and the direction indicating lamp module includes a plurality of direction indicating lamps.

In another preferred embodiment of the present invention, the input module is a connection interface, such as USB interface, RS-232 interface, Blue-Tooth interface or any other equivalent interface.

In another preferred embodiment of the present invention, the GPS navigation device without requiring a map database comprises: a casing; a touch display screen, installed on the casing, for inputting turning point coordinates and pre-turning point coordinates; a global positioning system, installed in the casing and electrically coupled to the touch display screen, for generating position coordinates of the GPS navigation device by a satellite positioning method, and outputting a direction instruction according to the turning point coordinates and the pre-turning point coordinates to guide a traveling direction; and a memory device, installed in the casing and electrically coupled to the global positioning system, for storing the turning point coordinates and the pre-turning point coordinates; wherein the navigation information is displayed on the touch display screen.

To achieve the aforementioned and other objectives, the GPS navigation method without requiring a map database in accordance with the present invention comprises the steps of: (A) storing a plurality of turning point coordinates and corresponding pre-turning point coordinates in a GPS navigation device according to a navigation path; (B) using a global positioning system in the GPS navigation device to generate position coordinates of a current position of the GPS navigation device; (C) determining a status of the position coordinates to output a corresponding direction instruction according to the turning point coordinates and the corresponding pre-turning point coordinates; and (D) displaying the corresponding direction instruction by the GPS navigation device. Step (C) further comprises: outputting a direction instruction of making a turn if the position coordinates correspond to any of the turning point coordinates, or outputting a direction instruction of preparing to make a turn according to a desired turning direction if the position coordinates correspond to any of the pre-turning point coordinates, or outputting a direction instruction of going straight if the position coordinates do not correspond to any of the turning point or pre-turning point coordinates. After Step (D) completes, the procedure of the method returns to Step (B) and continues the navigation flow.

With the turning point coordinates and corresponding pre-turning point coordinates produced by the pre-planned path and the current position coordinates of the GPS navigation device, a guide to a travelling direction is given a GPS navigation device without requiring a map database. Without requiring a huge computation of a map database, the GPS navigation device can save power and improve the extended battery life of the device.

To make it easier for the examiner to understand the objects, characteristics and effects of this invention, we use a preferred embodiment together with the attached drawings for the detailed description of the invention.

### BRIEF DESCRIPTION OF THE DRAWINGS

FIG. 1 is a schematic view of planning a navigation path in accordance with the present invention;

FIG. 2A is a perspective view of a GPS navigation device in accordance with a first preferred embodiment of the present invention;

FIG. 2B is a functional block diagram of a GPS navigation device in accordance with a first preferred embodiment of the present invention;

FIG. 3A is a perspective view of a GPS navigation device in accordance with a second preferred embodiment of the present invention;

FIG. 3B is a functional block diagram of a GPS navigation device in accordance with a second preferred embodiment of the present invention;

FIG. 4 is a functional block diagram of a GPS navigation device in accordance with a third preferred embodiment of the present invention;

FIG. 5 is a functional block diagram of a GPS navigation device in accordance with a fourth preferred embodiment of the present invention; and

FIG. 6 is a flow chart of a GPS navigation method of the present invention.

### DESCRIPTION OF THE PREFERRED EMBODIMENTS

Other features and advantages of the present invention will become apparent in the following detailed description of the preferred embodiments with reference to the accompanying drawings.

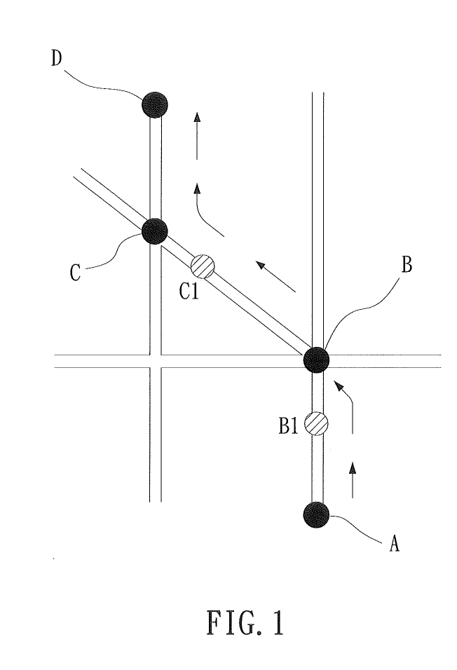

With reference to FIG. 1 for a schematic view of planning a navigation path in accordance with the present invention, turning point coordinates and corresponding pre-turning point coordinates are located in a navigation path pre-planned by a user before the navigation takes place, wherein the point coordinates are latitude and longitude coordinates. In FIG. 1, the planned navigation path is A→B→C→D, and the turning points in this path are A, B, C and D. Since the GPS navigation device comes with a satellite positioning function, therefore the current position coordinates of the GPS navigation device can be outputted immediately. The navigation function can be achieved by inputting the turning point coordinates into the GPS navigation device in advance. In other words, if the GPS navigation device is situated at a position having the turning point coordinates, then the position coordinates of the GPS navigation device outputted by a GPS system will match the turning point coordinates. Now, the GPS navigation device will display a turning direction according to the matched result to achieve the navigation function.

However, the pre-turning point coordinates can be set before reaching each turning point, so that users can know about the turning direction in advance before making a turn. If the position coordinates of the GPS navigation device and the pre-turning point coordinates are matched, then the GPS navigation device will display the desired turning direction according to the matched result to achieve the effect of noticing the users in advance. When a user reaches a turning point, the turning point coordinates are provided for indicating a turning instruction. In FIG. 1, the pre-turning point of the turning point B is B1, and the pre-turning point of the turning point C is C1. If the GPS navigation device is situated at B1, then a pre-turning direction instruction will be display to notice the user to get ready for making a left turn. If the GPS navigation device is situated at B, it shows that the user has already turned to a correct direction of the path, and the GPS navigation device will display a direction instruction of going straight ahead along the navigation path. If the GPS navigation device is situated at C1, then a direction pre-turning instruction of making a right turn will be display to notice the user to get ready for making a right turn when approaching the turning point. When the user receives a direction instruction of going straight ahead, it indicates that the turn has been made. In addition, the distance between the pre-turning point coordinates and the turning point coordinates can be set according to actual requirements. For example, such distance can be set to 5 meters, 10 meters or 20 meters, etc. When the user reaches a turning point or a pre-turning point, different methods for displaying such information can be set, so that the user can identify a pre-turning hint and a turning hint easily.

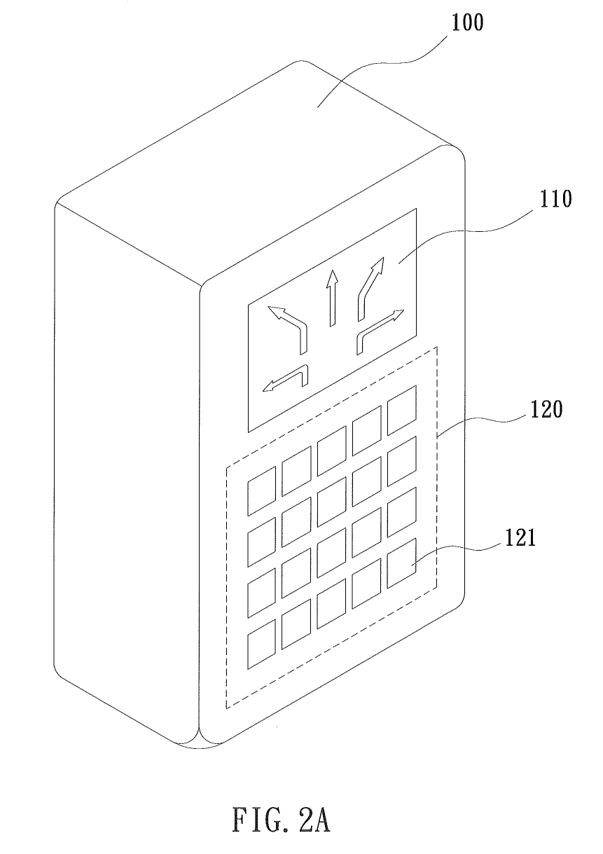

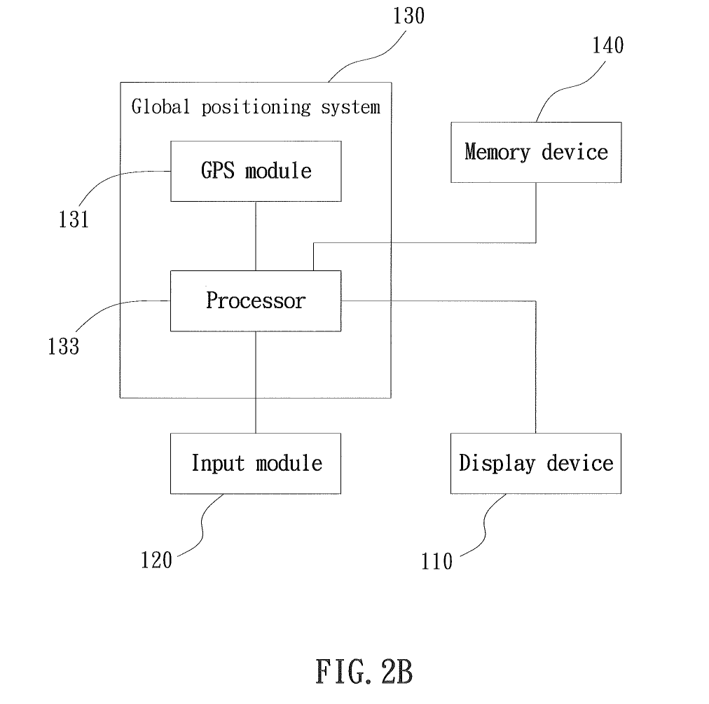

With reference to FIGS. 2A and 2B for a perspective view and a functional block diagram of a GPS navigation device in accordance with a first preferred embodiment of the present invention respectively, the GPS navigation device comprises: a casing 100, a display device 110 and an input module 120, wherein the display device 110 and the input module 120 are installed on the casing 100. The display device 110 in accordance with the preferred embodiment as shown in FIG. 2 is a display screen, such as a liquid crystal display screen, an OLED display screen or any other equivalent display screen, for displaying the direction instruction, wherein a digital angle gauge can be adopted or used together with the display screen for indicating a direction instruction. The input module 120 is provided for inputting the aforementioned turning point coordinates and pre-turning point coordinates, and the input module 120 is a push-button device 121 or any other equivalent input device. The casing 100 further includes a global positioning system 130 and a memory device 140 installed therein as shown in the functional block diagram of FIG. 2B, wherein the global positioning system 130 is electrically coupled to the display device 110, the input module 120 and the memory device 140. The global positioning system 130 is provided for generating position coordinates of the GPS navigation device by a satellite positioning method. The global positioning system 130 includes a GPS module 131 and a processor 133, wherein the GPS module 131 is provided for receiving a satellite signal, and the processor 133 is used for computing the position coordinates. The memory device is provided for storing the turning point coordinates and the pre-turning point coordinates, such that the processor 133 can compare and match the position coordinates of the GPS device with the turning point coordinates and the pre-turning point coordinates. In this preferred embodiment, the memory device 140, the display device 110 and the input module 120 are electrically coupled to the processor 133. The memory device 140 can be any one of various different types of storage media.

The GPS module 131 and the processor 133 can be integrated as a processor chip, and the memory device 140, the display device 110 and the input module 120 are electrically coupled to the processor chip.

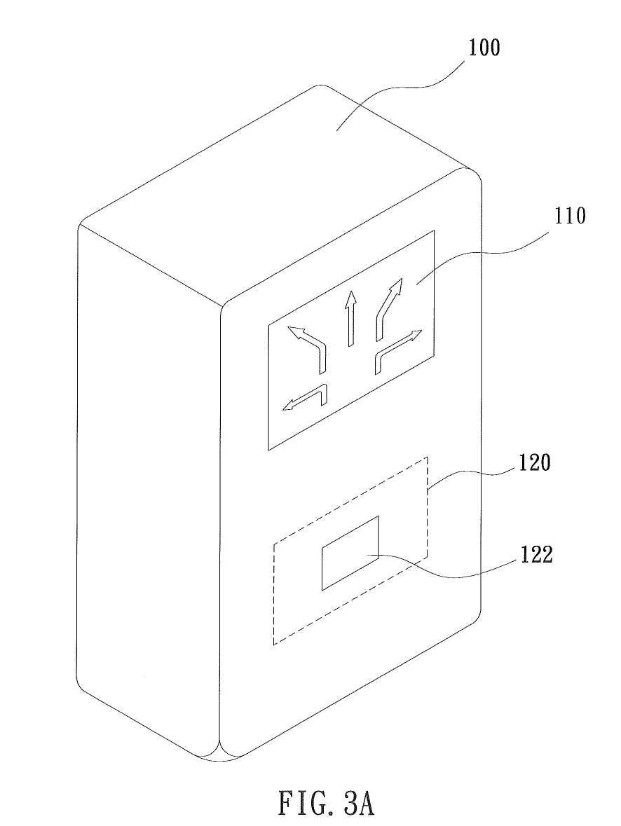

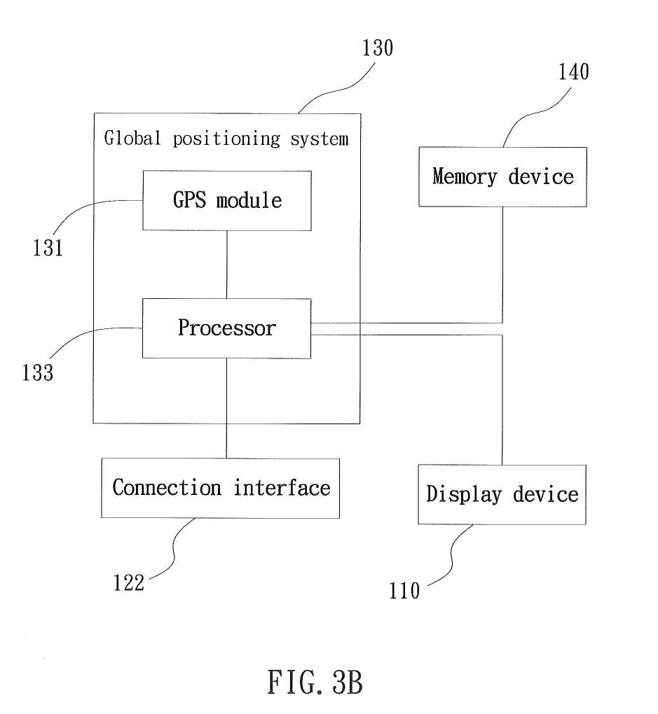

With reference to FIGS. 3A and 3B for a perspective view and a functional block diagram of a GPS navigation device in accordance with a second preferred embodiment of the present invention, the input module 120 is a connection interface 122 such as USB interface, RS-232 interface, Blue-Tooth interface or any other equivalent interface. Users can plan and load the turning point coordinates and the pre-turning point coordinates into other electronic devices such as a computer, and the turning point coordinates and the pre-turning point coordinates can be inputted into a memory device 140 of the GPS navigation device through the connection interface 122.

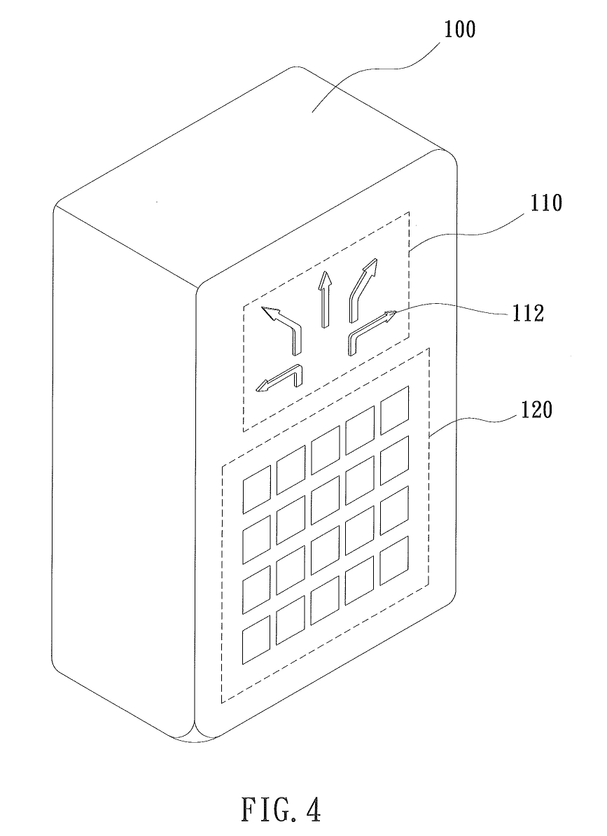

With reference to FIG. 4 for a perspective view of a GPS navigation device in accordance with a third preferred embodiment of the present invention, the display device 110 is a direction indicating lamp module 112, and the direction indicating lamp module 112 further includes a plurality of direction indicating lamps. FIG. 4 shows one of the examples only, wherein quantity of the direction indicating lamp modules 112 and the indicating direction can be set according to actual requirements. In this preferred embodiment, a lit signal light indicates a direction directly, and such signal light can be set with different colors or any other method to indicate a pre-turning direction instruction and a direction instruction of going straight ahead, so that users can identify a pre-turning hint.

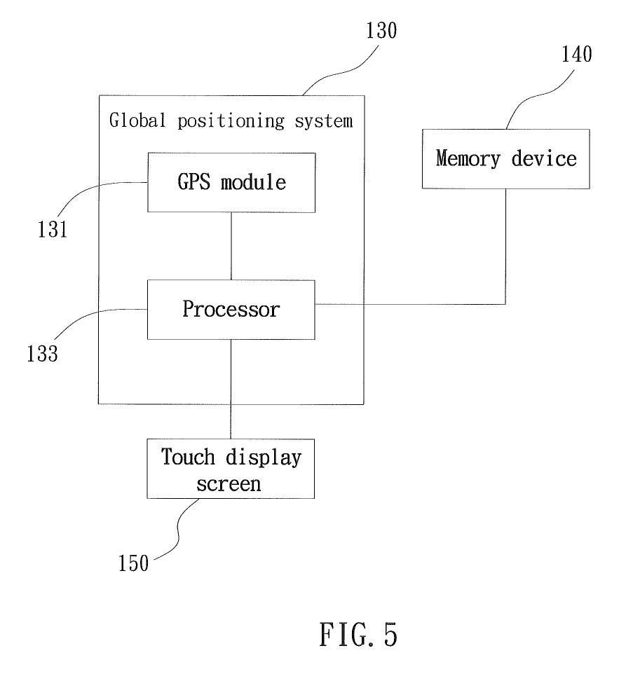

With reference to FIG. 5 for a functional block diagram of a GPS navigation device in accordance with a fourth preferred embodiment of the present invention, the global positioning system is electrically coupled to a touch display screen 150, for generating position coordinates of the GPS navigation device by a satellite positioning method, and outputting a direction instruction according to the turning point coordinates and the pre-turning point coordinates to guide a traveling direction. The touch display screen 150 is integrated with the input module 120 and the display device 110. Similarly, the GPS module 131 and the processor 133 can be integrated as a processor chip, and the memory device 140 and the touch display screen 150 are electrically coupled to the processor chip.

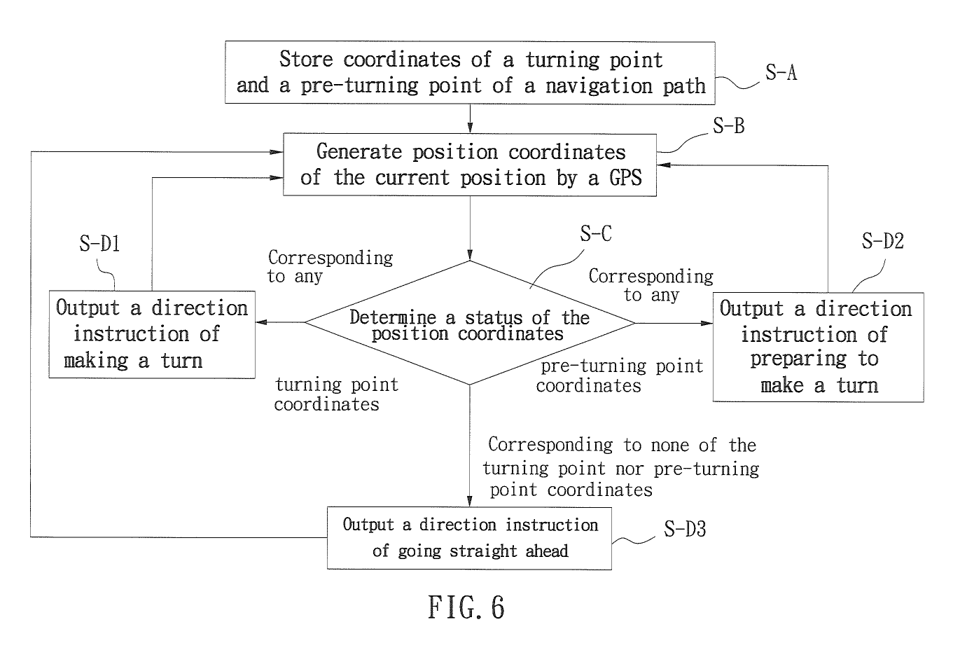

With reference to FIG. 6 for a flow chart of a GPS navigation method without requiring a map database in accordance with the present invention, the GPS navigation method comprises the steps of: (S-A) storing a plurality of turning point coordinates and corresponding pre-turning point coordinates into a GPS navigation device according to a navigation path; (S-B) generating position coordinates of a current position of the GPS navigation device by a GPS system; (S-C) determining a status of the position coordinates to output a corresponding direction instruction according to the turning point coordinates and the corresponding pre-turning point coordinates; and (S-D) displaying the corresponding direction instruction by the GPS navigation device. In FIG. 6, Step (S-D) further comprises Steps (S-D1˜3). If the position coordinates correspond to any of the turning point coordinates, then a direction instruction of making a turn is outputted in the Step (S-D1). If the position coordinates correspond to any of the pre-turning point coordinates, then a direction instruction of preparing to make a turn according to a desired turning direction in Step (S-D2). If the position coordinates correspond to none of the turning point or pre-turning point coordinates, then a direction instruction of going straight ahead is outputted in Step (S-D3). After Steps (S-D1˜3) are completed, the procedure will return to Step (S-B) to continue the navigation flow and complete the navigation for the entire route. In Step (S-D3), the direction instruction is outputted for going straight ahead refers to a route from B to C1 as shown in FIG. 1, wherein the traveling direction is fixed, and the position coordinates of the GPS navigation device will not match with any turning point or pre-turning point coordinates, so that the outputted direction instruction is a direction instruction of going straight ahead, which is the same as maintaining the current traveling direction. In Step (S-C), the position coordinates of the GPS navigation device are compared with the turning point coordinates and the pre-turning point for determining a status of the position coordinates and outputting a corresponding direction instruction.

In FIG. 2B, Step (S-A) inputs and stores the plurality of turning point coordinates and pre-turning point coordinates into the memory device 140 through the input module 120; Step (S-B) generates position coordinates of the current position of the GPS navigation device by the GPS system 130; and Step (S-C) comparing and matching the position coordinates of the current position of the GPS navigation device with the coordinates data previously inputted the memory device 140 to output the corresponding direction instruction by the processor 133.

Therefore, the GPS navigation device without requiring a map database and the method in accordance with the present invention uses the turning point coordinates and the corresponding pre-turning point coordinates generated by the pre-planned route together with the position coordinates of the current position of the GPS navigation device for guiding a traveling direction, so that the GPS device can achieve the navigation function without requiring a map database.

Table 1 is an example for an indication of the GPS navigation device according to FIG. 1, the display shows an indication direction corresponding to the location of the GPS navigation device along the navigation path.

TABLE 1

| | | B1 | B | C1 | C |
|---|---|---|---|---|---|
| Current | | (Pre-turning | (Turning | (Pre-turning | (Turning |
| position | A | point) | point) | point) | point) |
| Indication direction | 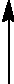 | 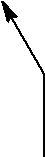 | 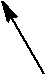 | 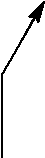 | 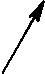 |

In summation of the description above, the present invention provides a feasible design and complies with patent application requirements, and thus is duly filed for patent application.

While the invention has been described by means of specific embodiments, numerous modifications and variations could be made thereto by those skilled in the art without departing from the scope and spirit of the invention set forth in the claims.

What is claimed is:

1. A global positioning system (GPS) navigation device without requiring a map database, comprising:
a casing;
an input module, installed on the casing, for inputting turning point coordinates and pre-turning point coordinates;
a global positioning system, installed in the casing and electrically coupled to the input module, for generating position coordinates of the GPS navigation device by a satellite positioning method, and outputting a direction instruction to guide a traveling direction according to the turning point coordinates and the pre-turning point coordinates;
a memory device, installed in the casing and electrically coupled to the global positioning system, for storing the turning point coordinates and the pre-turning point coordinates; and
a display device, installed on the casing and electrically coupled to the global positioning system, for displaying the direction instruction.

2. The GPS navigation device without requiring a map database as recited in claim 1, wherein the display device is a direction indicating lamp module.

3. The GPS navigation device without requiring a map database as recited in claim 2, wherein the direction indicating lamp module includes a plurality of direction indicating lamps.

4. The GPS navigation device without requiring a map database as recited in claim 1, wherein the display device is a display screen.

5. The GPS navigation device without requiring a map database as recited in claim 1, wherein the input module is a connection interface.

6. A GPS navigation device without requiring a map database, comprising:
a casing;
a touch display screen, installed on the casing, for inputting a turning point coordinates and a pre-turning point coordinates;
a global positioning system, installed in the casing and electrically coupled to the touch display screen, for generating position coordinates of the GPS navigation device by a satellite positioning method, and outputting a direction instruction to guide a traveling direction according to the turning point coordinates and the pre-turning point coordinates; and
a memory device, installed in the casing and electrically coupled to the global positioning system, for storing the turning point coordinates and the pre-turning point coordinates;
wherein the navigation information is displayed on the touch display screen.

7. A global positioning system (GPS) navigation method without requiring a map database, comprising the steps of:
(A) storing a plurality of turning point coordinates and their corresponding pre-turning point coordinates into a GPS navigation device according to a navigation path;
(B) generating position coordinates of a current position of the GPS navigation device by a GPS system;
(C) determining a status of the position coordinates to output a corresponding direction instruction according to the turning point coordinates and the corresponding pre-turning point coordinates; and
(D) displaying the corresponding direction instruction by the GPS navigation device.

8. The GPS navigation method without requiring a map database as recited in claim 7, wherein Step (C) further comprises a step of outputting a direction instruction of making a turn, if the position coordinates correspond to any of the turning point coordinates.

9. The GPS navigation method without requiring a map database as recited in claim 7, wherein Step (C) further comprises a step of outputting a direction instruction of preparing to make a turn according to a desired turning direction, if the position coordinates correspond to any of the pre-turning point coordinates.

10. The GPS navigation method without requiring a map database as recited in claim 7, wherein Step (C) further comprising a step of outputting a direction instruction of going straight ahead, if the position coordinates correspond to none of the turning point or the pre-turning point coordinates.

11. The GPS navigation method without requiring a map database as recited in claim 7, further comprising a step of returning to Step (B) after Step (D) is completed.
